(19) United States
(12) Patent Application Publication
(10) Pub. No.: US 2006/0131462 A1
(43) Pub. Date: Jun. 22, 2006

(54) Turboelectric arresting gear

(76) Inventors: Leo D. Holland, San Diego, CA (US); Carmelo Rodriguez, Cardiff, CA (US)

Correspondence Address: NEIL K. NYDEGGER;NYDEGGER & ASSOCIATES, 348 Olive Street, San Diego, CA, 92103, US

(21) Appl. No.: 11/017,435

(22) Filed: Dec. 20, 2004

(51) Int. Cl. B64F 1/02

(52) U.S. Cl. 244/110 G

(57) ABSTRACT

An arresting gear for quickly decelerating a moving object includes an elongated shaft that defines a rotation axis. A tapered drum that is wound with a purchase cable is mounted on the shaft for rotation about the axis. The drum and the shaft are rotated during the pay out of cable from the drum as the moving object engages and then pulls on the cable. The arresting gear includes an energy-dissipating fluid turbine, such as a water twister, that is mounted on the shaft to apply a torque on the shaft that acts to decelerate the rotating shaft. To complement the energy-dissipating fluid turbine, an electric motor is coupled to the shaft for creating a decelerating torque on the shaft. An electric motor control system is configured to use motor rotation feedback from the electric motor to pay out the cable from the drum at a substantially constant tension.

### FIELD OF THE INVENTION

The present invention pertains generally to arresting gear for decelerating a moving object. More particularly, the present invention pertains to arresting gear for smoothly decelerating objects such as aircraft and elevators. The present invention is particularly, but not exclusively, useful as a system for decelerating a moving object that is operable for a wide range of object types, weights and speeds.

### BACKGROUND OF THE INVENTION

Present-day aircraft normally require the use of runways that are approximately 5,000 to 8,000 feet long in order to land safely. In some applications, however, it is desirable to stop these same aircraft within a few hundred feet. This feat is typically accomplished using arresting gear that can bring a moving object to a controlled stop by absorbing and dispelling energy developed by the moving object. For the case of a landing aircraft, an arresting gear system typically includes a pendant that is suspended over and spans the width of the runway. The pendant is positioned to catch and engage an arresting hook (e.g. tail hook) that is mounted on the landing aircraft. A purchase cable is provided that is attached to and extends from the pendant to an energy absorbing system (typically referred to as an arresting engine).

Heretofore, the standard energy absorbing system (i.e. arresting engine) that has been commonly used incorporates a hydraulic system that absorbs energy by forcing a ram into a cylinder holding a pressurized viscous hydraulic fluid. The hydraulic fluid is forced out of the cylinder through a control valve that meters the flow to an accumulator until the decelerated object is brought to a smooth, controlled stop.

These hydraulic arresting engines have several drawbacks. Primary among these drawbacks is the generation of a high stress in the purchase cable, the pendant, the tail hook and the aircraft frame. This high stress causes a sudden deceleration or “jerk” that is imparted on the decelerating object immediately after the pendant engages the arresting hook. Contributing to this unwanted “jerking” of the object is a “kink wave” that is often generated in the purchase cable. The “kink wave” reflects back and forth between the decelerating object and the arresting engine. The resulting superimposed waves add in accordance with well-know wave principles increasing the “jerk” experienced by the decelerating object.

This rapid deceleration (i.e. jerk) is especially pronounced when relatively heavy objects, such as a large aircraft, are arrested. Aggravating this phenomenon is the fact that modern aircraft are being designed to be larger and heavier than ever before. Specifically, modern advanced aircraft are designed to carry larger, heavier payloads, ever-increasing amounts of fuel and more elaborate, heavier electronic systems. As a consequence, there exists a need to arrest relatively heavy aircraft while minimizing the rapid deceleration (i.e. jerk) that is often caused by currently available arresting gear.

In addition to the problems described above regarding relatively heavy aircraft, currently available hydraulic energy absorbing systems are also problematic for relatively light aircraft which typically land at relatively high speeds (e.g. 100 mph). These light aircraft include unmanned air vehicles (UAV's) which are being landed on short runways recently with increasing frequency. For example, UAV's may be used in telecommunication applications to create the equivalent of a cell tower in an undeveloped area. For this application, it is often necessary to land the UAV's with only a relatively short runway. Because these aircraft are designed primarily with weight in mind, they typically lack the strong structural features required to withstand a relatively large decelerating “jerk” during landing. As a result, these lighter aircraft often sustain structural damage during an arrestment.

Another factor that is important when considering arresting gear is reliability. Failure of an arresting gear can cause loss of life, loss of aircraft and damage to equipment and personnel at the end of the short runway. With this in mind, it is important that all aspects of the arresting gear including all components, sub-systems and control systems be designed to be fault tolerant and highly reliable. Other important design factors for an arresting gear include the size of the arresting gear (because space near the short runway is often limited), energy considerations and the amount of maintenance required to ensure the system remains at a state of constant readiness.

In light of the above, it is an object of the present invention to provide systems suitable for the purposes of arresting a moving object while minimizing rapid deceleration (i.e. jerk) of the object. It is another object of the present invention to provide a system for decelerating a moving object that is operable for a wide range of object types and weights and can be operated under a variety of conditions. It is yet another object of the present invention to provide a system for decelerating a moving object that is highly reliable and fault tolerant. Yet another object of the present invention is to provide a system for decelerating a moving object that is easy to maintain, relatively simple to implement, and comparatively cost effective.

### SUMMARY OF THE INVENTION

The present invention is directed to an arresting gear for quickly decelerating and arresting a moving object. The arresting gear is typically mounted on the deck and galleries of a ship and allows an object to be decelerated in a relatively short distance. In one application, the invention is used to decelerate a landing aircraft and the arresting gear typically includes a steel cross pendant that is suspended over and spans the width of a runway. The pendant is positioned to catch and engage an arresting hook (e.g. tail hook) that is mounted on the landing aircraft. The arresting gear further includes a pair of lines and a pair of arresting engines. For the arresting gear of the present invention, each line can be a synthetic or a steel purchase cable. Moreover, each end of the pendant is attached to a separate line and each line extends from the pendant to a respective arresting engine.

For the present invention, each arresting engine includes an elongated shaft that defines a rotation axis in the direction of shaft elongation. A tapered drum is mounted on the shaft for rotation about the axis. In accordance with the present invention, a portion of each line is wound on a respective drum. With this cooperation of structure, the arresting engine pays out line from the drum as the moving object engages and then pulls on the line. The pay out of line from the drum, in turn, rotates the drum and the shaft about the axis.

In accordance with the present invention, the arresting engine includes an energy-dissipating fluid turbine, such as a water twister, that is mounted on the shaft to apply a torque on the shaft that can decelerate the rotating shaft. To complement the energy-dissipating fluid turbine, an electric motor is coupled to the shaft for creating a decelerating torque on the shaft when the line is pulled by the moving object. For aircraft landing applications, an electric motor control system is provided that is configured to cause the electric motor to produce an accelerating torque on the shaft upon initial engagement of the pendant with the arresting hook to allow for a smooth engagement between the pendant and the arresting hook. After a smooth engagement has been obtained, the electric motor control system causes the electric motor to generate a decelerating torque on the shaft to slow the landing aircraft. This decelerating torque complements the decelerating torque provided by the energy-dissipating fluid turbine. In addition, the electric motor control system is configured to use motor rotation feedback from the electric motor to pay out the line from the drum at a substantially constant tension.

The arresting engine can also include a mechanical brake, which for example, can be a disk brake system. For the disk brake system, a disk is mounted on the shaft for interaction with one or more calipers to create a decelerating torque on the shaft when the line is pulled by the moving object. The mechanical brake is provided as a backup system and can be applied if one of the primary decelerating systems fails (i.e. if either the energy-dissipating fluid turbine or the electric motor fails).

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic view of an arresting gear for quickly decelerating and arresting a landing aircraft; and

FIG. 2 is a perspective view of an arresting engine with portions removed to show internal features.

### DESCRIPTION OF THE PREFERRED EMBODIMENTS

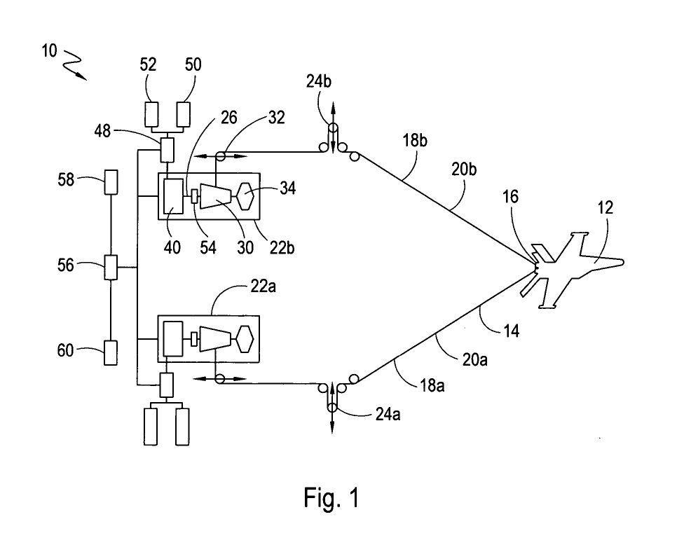

Referring to FIG. 1, an arresting gear in accordance with the present invention is shown and generally designated 10. In functional overview, the arresting gear 10 is designed to quickly decelerate and arrest a landing aircraft 12 using a relatively short runway. The arresting gear 10 is typically mounted on the ground or the deck of a ship to decelerate and arrest an aircraft 12 using a relatively short runway. Although the arresting gear 10 is shown configured for an application in which an aircraft is to be decelerated and arrested, those skilled in the pertinent art will quickly appreciate that the arresting gear 10 shown can be adapted to decelerate other moving objects, including but not limited to, elevator platforms for freight elevators and for use in high-rise structures.

FIG. 1 shows the arresting gear 10 includes a cross-deck pendant 14 that is operationally suspended over and spans the width of the runway. Those skilled in the pertinent art will appreciate that the pendant 14 is to be positioned to catch and engage an arresting hook 16, such as a tail hook, that is mounted on the landing aircraft 12. In a typical embodiment of the arresting gear 10, the pendant 14 is a steel cross pendant having a four wire configuration. FIG. 1 further shows that the arresting gear 10 includes a pair of lines 18a,b. Lines 18a,b can be, but are not limited to, purchase cables and tapes including synthetic or steel purchase cables and tapes. For the arresting gear 10, the lines 18a,b are preferably low mass, synthetic purchase cables. The use of low mass synthetic purchase cable is desirable because it reduces overall system inertia, reduces structural loads, and reduces the size of sheave dampers.

As further shown in FIG. 1, line 18a is connected to end 20a of pendant 14 and extends therefrom to an arresting engine 22a. Similarly, it can be seen that line 18b is connected to end 20b of pendant 14 and extends therefrom to an arresting engine 22b. Shock/spring assemblies 24a,b are coupled to respective lines 18a,b as shown to minimize the line tension impact of individual transverse and longitudinal waves in the lines 18a,b. In a typical embodiment, the shock/spring assemblies 24a,b are placed on a sheave, for example, just below the main deck sheave (not shown). Preferably, the shock used in the shock/spring assemblies 24a,b is of a short stroke type, similar to those used in industrial cranes and other commercial applications.

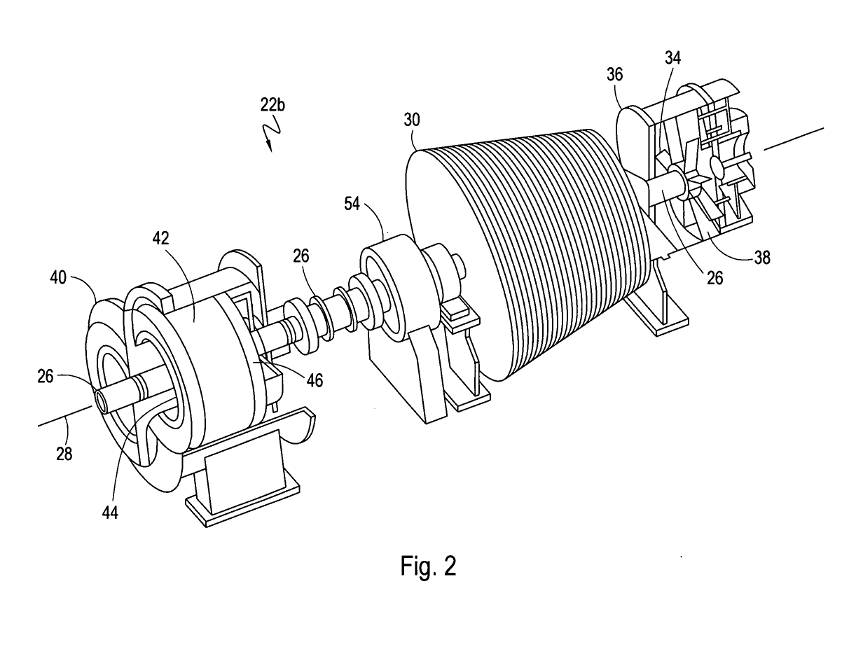

A better understanding of the arresting engines 22a,b can be obtained with cross-reference to FIGS. 1 and 2. To simplify the discussion, a single arresting engine 22 will be described with the understanding that both arresting engines 22a,b operate together to decelerate and arrest the aircraft 12. As shown in FIGS. 1 and 2, arresting engine 22b includes an elongated shaft 26 that defines a rotation axis 28 in the direction of shaft elongation. As further shown, a tapered drum 30 is mounted on the shaft 26 for rotation about the axis 28. For the arresting gear 10, the end of line 18b is attached to the drum 30 and a portion of line 18b is initially wound on the drum 30. Follower 32 is provided to allow the line 18b to wind and unwind on the drum 30. With this cooperation of structure, the arresting engine 22b pays out line 18b from the drum 30 as the landing aircraft 12 engages and then pulls on the pendant 14. The pay out of line 18b from the drum 30, in turn, rotates the drum 30 and the shaft 26.

Continuing with cross-reference to FIGS. 1 and 2, it can be seen that the arresting engine 22b includes an energy-dissipating fluid turbine 34, such as the water twister shown, that is mounted on the shaft 26. As used herein, the term “energy-dissipating fluid turbine” and its derivatives means a shaft mounted device which can include a wheel or cylinder having one or more elements circumferentially mounted thereon which can include but are not limited to blades, paddles, vanes and buckets wherein the elements are positioned for interaction with a fluid during a rotation of the shaft to decelerate the rotation of the shaft. Thus, the term “energy-dissipating fluid turbine” includes, but is not necessarily limited to, devices known in the pertinent art as “water twisters”.

Functionally, the energy-dissipating fluid turbine 34 is provided to apply a torque on the shaft 26 that acts to decelerate the rotating shaft 26. As shown, the energy-dissipating fluid turbine 34 includes a housing 36 for holding a fluid (e.g. water) and a plurality of vanes 38 which are immersed in the fluid and rotate with the shaft 26 about the axis 28. In one embodiment of the arresting engine 22b, a water twister that is capable of varying its hydraulic drag (K-factor, ft-lb/rpm²) is used to accommodate a large range of arrestment energies. Specifically, this can be accomplished by raising buffer plates (not shown) between the vanes 38, to replace pump action between the rotor and stator by viscous shear. In a maximum-energy arrestment, the twister can exert a braking torque of 101,000 ft-lb, and 4,400 ft-lb in the minimum-energy case.

FIGS. 1 and 2 further show that the arresting engine 22b includes an electric motor 40 that is coupled to the shaft 26 for creating a decelerating torque on the shaft 26 when the line 18b is pulled by the landing aircraft 12. For the arresting gear 10, the motor 40 is preferably a three-phase induction motor of a low inertia design to allow the motor 40 to quickly accelerate or quickly decelerate the shaft 26. FIG. 2 illustrates a low inertia motor 40 which includes a cup shaped rotor 42 that is mounted on the shaft 26 and rotates therewith. The cylindrical portion of the cup-shaped rotor 42 is positioned between two stationary, electromagnetic windings 44, 46 that are each substantially cylindrical in shape (note a portion of winding 46 has been removed to reveal the cylindrical shape of the rotor 42). Thus, the cylindrical portion of the cup-shaped rotor 42 has a radius that is between the radius of the cylindrical electromagnetic winding 44 and the cylindrical electromagnetic winding 46. Typically, as shown, the motor 40 is positioned to interpose the drum 30 on the shaft 26 between the motor 40 and the energy-dissipating fluid turbine 34 to thereby balance the applied torque on the shaft 26.

As best seen in FIG. 1, the electric induction motor 40 is driven from an inverter 48 for retraction and tensioning of the line 18b prior to an arrestment and for control of the line 18b tension during the dynamic phase of an arrestment. During the braking phase of an arrestment, the motor 40 acts as a generator feeding power through the inverter 48 to recharge a capacitor bank 50 and dumping excess energy to water-cooled resistors 52.

FIGS. 1 and 2 also show that the arresting engine 22b includes a mechanical brake 54, which, for the embodiment shown, is a disk brake system. Structurally, the disk brake system includes a disk that is mounted on the shaft 26 for rotation therewith and interaction with one or more stationary calipers. When actuated, the mechanical brake 54 creates a decelerating torque on the rotating shaft 26 when the line 18b is pulled by the landing aircraft 12. The mechanical brake 54 is provided as a backup system to control an arrestment and can be applied if one of the primary decelerating systems fails (i.e. if either the energy-dissipating fluid turbine 34 or the electric motor 40 or its power train fails). Furthermore, the mechanical brake 54 is used to hold the tension in line 18b in the ready condition before an arrestment, and to hold the aircraft 12 thrust at the end of an arrestment, eliminating both loads on the motor 40.

As best seen in FIG. 1, the arresting gear 10 includes a control system which typically includes a dynamic control subsystem 56, an operator's workstation 58 and a maintainer's workstation 60. As shown, the control system is electrically connected to the arresting engines 22a,b and the inverters 48. The control system includes an electric motor control system that is configured to allow the electric motor 40 to produce an accelerating torque on the shaft 26 upon initial engagement of the pendant 14 with the arresting hook 16 to allow for a smooth engagement between the pendant 14 and the arresting hook 16. After a smooth engagement has been obtained, the electric motor control system causes the electric motor 40 to generate a decelerating torque on the shaft 26 to slow the landing aircraft 12. The decelerating torque provided by the electric motor 40 complements the decelerating torque provided by the energy-dissipating fluid turbine 34. During the dynamic phase of an arrestment, the electric motor control system uses feedback from the motor 40 including rotation and position information to pay out the line 18 from the drum 30 at a substantially constant tension and control the final stopping position of the aircraft.

For the arresting gear 10, the use of a passive, energy-dissipating fluid turbine 34 in combination with the low inertia electric motor 40 allows for controlled arrestments over a relatively large operating envelope (i.e. large range of aircraft weights and landing speeds) without the bulk and weight of the power trains required if an electric motor was used alone. It is anticipated for the arresting gear 10 that in a maximum-energy arrestment, approximately 65% of the aircraft energy is absorbed by the energy-dissipating fluid turbine 34, approximately 25% by the dump resistors 52, and approximately 10% is recycled.

As indicated above, for a low-energy, high-speed arrestment, the motor 40 accelerates the shaft 26 after engagement of the pendant 14 by the aircraft hook 16 to reduce the apparent system inertia. This feature, in combination with the use of a low-mass synthetic purchase cable, allows the arresting gear 10 to meet a wide range of hook load, g-load, and peak-to-mean stress requirements throughout the operating envelope.

While the particular Turboelectric Arresting Gear as herein shown and disclosed in detail are fully capable of arresting the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A system for controlling the pay out tension of a line used to decelerate a moving object, said system comprising:
an elongated shaft defining a rotation axis;
a drum configured to allow a portion of the line to be wound thereon, said drum mounted on said shaft for rotation about said axis;
an energy-dissipating fluid turbine mounted on said shaft for creating a decelerating torque on said shaft when said line is pulled by the moving object; and
an electric motor mounted on said shaft for creating a decelerating torque on said shaft when said line is pulled by the moving object.

2. A system as recited in claim 1 further comprising a mechanical brake for creating a decelerating torque on said shaft when said line is pulled by the moving object.

3. A system as recited in claim 2 wherein said mechanical brake comprises a disk brake system having a disk mounted on said shaft.

4. A system as recited in claim 1 wherein said moving object is a landing aircraft and said line is a steel cable.

5. A system as recited in claim 1 further comprising an inverter, a capacitor bank, at least one resistor and an electric motor control system configured to energize said electric motor using said inverter to produce an accelerating torque on said shaft after said line is initially pulled by said moving object to provide a smooth engagement between the line and object and thereafter feed power from said motor to said capacitor bank and said resistor to decelerate said shaft.

6. A system as recited in claim 1 further comprising an electric motor control system configured to use motor rotation feedback from said electric motor to pay out said line from said drum at a substantially constant tension.

7. A system as recited in claim 1 wherein said drum is tapered.

8. A system as recited in claim 1 wherein said electric motor is an induction motor.

9. A system as recited in claim 1 wherein said energy-dissipating fluid turbine is a water twister.

10. An arresting gear comprising:
a pendant positionable for engagement with an arresting hook on a landing aircraft;
a first line and a second line, each line extending from said pendant;
a first arresting engine coupled with said first line; and
a second arresting engine having a shaft coupled to said second line, said second arresting engine having an energy-dissipating fluid turbine mounted on said shaft for creating a decelerating torque on said shaft when said second line is pulled by the landing aircraft and an electric motor mounted on said shaft for creating a decelerating torque on said shaft when said second line is pulled by the landing aircraft.

11. An arresting gear as recited in claim 10 wherein said pendant is a steel cross pendant.

12. An arresting gear as recited in claim 10 wherein said second line is a synthetic purchase cable.

13. An arresting gear as recited in claim 10 wherein said shaft is a first shaft, said first arresting engine comprises a second shaft coupled to said first line, said first arresting engine comprises an energy-dissipating fluid turbine mounted on said second shaft for creating a decelerating torque on said second shaft when said first line is pulled by the landing aircraft, and said first arresting engine comprises an electric motor mounted on said first shaft for creating a decelerating torque on said second shaft when said first line is pulled by the landing aircraft.

14. An arresting gear as recited in claim 10 wherein said second arresting engine comprises a tapered drum to couple said shaft to said second line.

15. An arresting gear as recited in claim 10 wherein said second arresting engine further comprises a mechanical brake for creating a decelerating torque on said shaft when said second line is pulled by the landing aircraft.

16. An arresting gear as recited in claim 10 wherein said electric motor is an induction motor.

17. An arresting gear as recited in claim 10 wherein said energy-dissipating fluid turbine is a water twister.

18. An arresting engine for controlling the pay out of a line used to arrest a landing aircraft, said arresting engine:
a shaft;
a means for coupling the line to said shaft wherein said shaft rotates during pay out of said line from said shaft;
an energy-dissipating fluid turbine for creating a decelerating torque on said shaft during pay out of said line from said shaft; and
a motor for creating a decelerating torque on said shaft during pay out of said line from said shaft.

19. An arresting engine as recited in claim 18 further comprising a mechanical brake for creating a decelerating torque on said shaft when said line is pulled by the landing aircraft.

20. An arresting engine as recited in claim 18 further comprising an electric motor control system configured to cause said electric motor to produce an accelerating torque on said shaft after said line is initially pulled by said landing aircraft followed by a decelerating torque on said shaft.
